(19) United States
(12) Patent Application Publication
(10) Pub. No.: US 2016/0343270 A1
(43) Pub. Date: Nov. 24, 2016

(54) IMPROVEMENTS IN TRAINING DEVICES FOR TOOTH BRUSHING

(71) Applicant: POGOLAB LIMITED, London (GB)

(72) Inventors: Wen Zheng, London (GB); Mark David McKeague, London (GB)

(73) Assignee: POGOLAB LIMITED, London (GB)

(21) Appl. No.: 15/107,251

(22) PCT Filed: Oct. 24, 2014
(86) PCT No.: PCT/GB2014/000432

§ 371 Date: Jun. 22, 2016

(30) Foreign Application Priority Data
Oct. 25, 2013 (GB) 1318916.2

(51) Int. Cl. G09B 19/00; G09B 5/06; G09B 5/12

(52) U.S. Cl. CPC G09B 19/0084; G09B 5/125; G09B 5/065

(57) ABSTRACT

A training device for use when brushing teeth, the training device comprising: a display means for displaying a visual representation of a set of teeth, said visual representation configured to display the set of teeth as a plurality of brushing zones; an indication means for indicating on the visual representation each of the plurality of brushing zones; a timer for timing a brushing session, and brushing intervals within said brushing session; and, a programmable means operatively connected to said indication mean and said timer, the programmable means configured to control the indication means to indicate each brushing zone for each successive brushing interval during a brushing session, wherein the programmable means is configured to randomise the duration of each brushing interval, whilst ensuring that during a brushing session each brushing zone is indicated for a preset overall duration.

This invention pertains generally to the field of training devices for brushing teeth, and in particular training devices for use by children when brushing their teeth.

Dental decay and gum disease are becoming extremely common in people throughout the world, and in particular in children. These dental problems are caused by bacteria within the mouth that can be controlled and prevented through good oral hygiene. Whilst children are encouraged to brush their teeth twice a day to remove dental plaque and tartar from building up within their mouth, there is little guidance to ensure that they brush effectively and thoroughly. There are a number of factors that contribute to an effective tooth brushing technique, that includes type of toothbrush used, angle of brush head, brushing motion, time spent brushing, tooth and gum coverage with the brush, brushing pressure. A number of these factors are very difficult for a child to determine without help or feedback.

Most children are shown how to brush their teeth by their dentist, who typically demonstrates a good brushing technique on a model of a mouth within their surgery. The child is then expected to replicate this demonstration the next time they brush their teeth when back home, and twice a day from then onwards. They are often advised to brush for a specific time period, such as two minutes, and to angle the brush head to a 45 degree angle to the gum line. They are advised to ensure that they brush the outer and inner surfaces of each tooth, along with the chewing surface. A circular brushing motion is also often suggested.

Toothbrushes are becoming far more advanced, and many children now use electric toothbrushes over a manual alternative. Some electric toothbrushes time a brushing session to ensure that a user brushes for two minutes, or for a preset amount of time. Some even alert the user as to when to move to a different section of their mouth, to help with ensuring that all teeth are cleaned during anyone brushing session. Some incorporate means to determine brushing pressure and brush head angle, and indicate whether a user is using the toothbrush correctly. However, whilst going some way towards improving a user's oral hygiene and tooth brushing habits, they are not likely to be successful in engaging a child, and can often become confusing when in use.

Electric toothbrushes specifically aimed at children have gone some way towards helping a child to brush correctly, and to keep them engaged during the brushing process, whilst also encouraging them to brush twice a day and for the recommended time. These include toothbrushes that play music, toothbrush docking stations with integral timing means, and even toothbrushes that interact with a toy to alert the child when it is time to brush. They do not however train the child to brush correctly, nor do they ensure that the child is in fact brushing their teeth. They do not provide much interactivity during the brushing process, and do not feedback as to how the child could improve. The toothbrushes with integral timing means, and alerts to suggest that you move to a different section of teeth, provide the same pattern each time. The alerts typically become ignored, and little attention is paid to ensuring that all teeth are cleaned.

The prior art shows a number of devices which attempt to address these needs in various ways.

WO 2009 149 545 (Mottram et al) discloses an electric toothbrush incorporating a digital training aid that is intended for use by children. The toothbrush incorporates a microprocessor and a display screen, the microprocessor generating pictorial images on the display screen. The toothbrush monitors the time spent actually brushing teeth, and brushing habits over a 24 hour period. The device is thought to motivate the child, whilst providing feedback to a parent of a child's brushing habits. However the interactivity with the child is thought to be limited with the child just following the same timed pattern each time they brush. The feedback to a parent is also not real-time.

GB 2 431 506 (Gibson-Watt) discloses an illustrated training aid with a pre-set sequence of lights and sounds to encourage users to carry out time sensitive sequences of activities such as brushing their teeth. The device is intended to help to build a good habit by repetitively following a timed sequence, and setting out the sequence through a series of illustrations. Whilst this device goes some way towards instructing a user to follow a timed sequence of events, or timed sequence of tooth brushing, the repetition of this sequence is likely to become ignored over time, with little else to engage and interact with the user.

U.S. Pat. No. 5,810,601 (Williams) discloses a dental hygiene instructional display that comprises a plurality of liquid crystal display segments depicting a plurality of toothbrush positions, with means to activate each liquid crystal display segment during successive intervals of time. The display shows brushing duration, brush stroke technique and location of brushing that the user should follow. Although the device helps with instilling good brushing habits providing the sequence of steps is followed each time, the repetition of the steps and the lack of feedback or interactivity with the user is unlikely to encourage them to improve their performance, or even to follow the instructions each time they brush their teeth.

U.S. Pat. No. 2,002,058 239 (Wang) discloses a teaching and entertaining apparatus that provides an electronic device to assist, teach and inspire a user to brush their teeth in the correct manner. The device comprises a visual and audible program for leading the user sequentially through the steps of the activity, to ensure the correct brushing technique for each tooth region, whilst ensuring that all teeth are brushed during a two minute brushing session. This device again goes some way towards engaging a user and instilling good brushing techniques, but the repetition of the steps are likely to be ignored one the user has become bored of following the same pattern.

Whilst the prior art appears to address the problem of engaging a child when brushing their teeth and instilling good oral hygiene techniques each time they brush, the repetition of the prior art through encouraging the user to follow the same sequence each time they brush is likely to cause the device to be ignored after a period of time. The prior art provides little feedback as to technique, and any feedback is not real-time. The prior art does not provide means to engage the user each time they brush, and to make a tooth brushing session into an interactive activity.

Preferred embodiments of the present invention aim to provide a tooth brushing training device that provides a different user experience each time they engage in a brushing session, with real-time feedback tracking their brushing session, and means to encourage and instruct in an interactive way. Also provided is a way to ensure each brushing sequence during a brushing session is different to the last sequence that the user followed, whilst ensuring that all teeth are brushed for the correct duration. In a further embodiment, the device aims to provide a means of taking into account a user profile when generating a brushing session, and a mean of obtaining brushing data from a brushing session and using this brushing data for analysis and feedback, whilst also using this brushing data in an interactive way through a gaming platform.

According to one aspect of the present invention, there is provided a training device for use when brushing teeth, the training device comprising:
a display means for displaying a visual representation of a set of teeth, said visual representation configured to display the set of teeth as a plurality of brushing zones;
an indication means for indicating on the visual representation each of the plurality of brushing zones;
a timer for timing a brushing session, and brushing intervals within said brushing session; and,
a programmable means operatively connected to said indication means and said timer, the programmable means configured to control the indication means to indicate each brushing zone for each successive brushing interval during a brushing session,
   wherein the programmable means is configured to randomise the duration of each brushing interval, whilst ensuring that during a brushing session each brushing zone is indicated for a preset overall duration.

Preferably, the display means comprises an LCD display.

Alternatively, the display means may comprise a plurality of light-emitting diodes.

In a further embodiment, the display means may comprise a smartphone or tablet device.

The indication means may comprise a plurality of light-emitting diodes configured to represent a set of teeth.

Preferably, the indication means is accompanied by an audible alert means.

The audible alert means may comprise a changing musical tune.

Preferably, the indication means is configured to indicate one of the following brushing zones for the duration of each brushing interval: upper left molars and bicuspids, upper right molars and bicuspids, upper cuspids and incisors, lower left molars and bicuspids, lower right molars and bicuspids, lower cuspids and incisors.

Preferably, the indication means is configured to indicate one of the following regions within each brushing zone for the duration of each brushing interval: outside surface, inside surface, chewing surface.

The visual representation may indicate brushing zones and at least one brushing technique for each brushing zone.

The visual representation may show a mirror image of a set of teeth.

The training device may be operatively connected to at least one sensor within a toothbrush handle, said sensor configured to obtain data for determining at least one of the following conditions: toothbrush head angle, brushing zone location, brushing motion pattern, brushing pressure, brushing speed.

The sensor may comprise a motion sensor.

Preferably, the motion sensor comprises an accelerometer.

The sensor may comprise a capacitative sensor.

The sensor may comprises a gyroscope.

Preferably, the at least one sensor comprises an accelerometer, a gyroscope and a pressure sensor to determine brushing frequency, brushing angle and brushing position.

The programmable means may be programmed for a particular user profile and/or user brushing history.

The training device may be operatively connected to the toothbrush handle through wireless means to wirelessly transfer brushing data from the at least one sensor.

The training device may comprise a processor configured to compare brushing data with preset brushing data for a particular user.

The processor may be configured to alter the programmable means to vary brushing intervals and brushing zones in response to any received brushing data for the user's successive brushing session.

The training device may provide real-time feedback as to brushing technique.

Preferably, said real-time feedback is in the form of an interactive game.

A user's performance within the interactive game may be real-time controlled by the user's brushing data during a particular brushing session.

The audible alert means may be configured to change according to the brushing data generated during a brushing session when compared with the preset brushing data.

The training device may comprise data storage means to store said brushing data for a particular user.

According to a further aspect of the present invention, there is provided a training device for use when brushing teeth, the training device comprising:
audible means for alerting a user where to brush their teeth;
a timer for timing a brushing session, and brushing intervals within said brushing session; and,
a programmable means operatively connected to said audible means and said timer, the programmable means configured to control the audible means to alert where to brush for each successive brushing interval during a brushing session,
   wherein the programmable means is configured to randomise the duration of each brushing interval, whilst ensuring that during a brushing session each brushing zone is indicated for a preset overall duration.

According to yet a further aspect of the present invention, there is provided a training device for use when brushing teeth, the training device comprising:
a display means for displaying a visual representation of a set of teeth;
a timer for timing a brushing session, and brushing intervals within said brushing session; and,
a programmable means operatively connected to said display means and said timer, the programmable means configured to control the display means to indicate each brushing zone for each successive brushing interval during a brushing session,
   wherein the display means is configured to indicate a specific brushing technique for each brushing zone.

Preferably, the display means is configured to display real-time feedback in the form of an interactive game.

An electric toothbrush handle may incorporate the aforementioned training device.

An electric toothbrush docking station may incorporate the aforementioned training device.

A retrofittable attachment for retrofitting to the handle of any manual and/or electric toothbrush may incorporate the training device.

For a better understanding of the invention and to show how embodiments of the same may be carried into effect, reference will now be made, by way of example, to the accompanying diagrammatic drawings, in which:

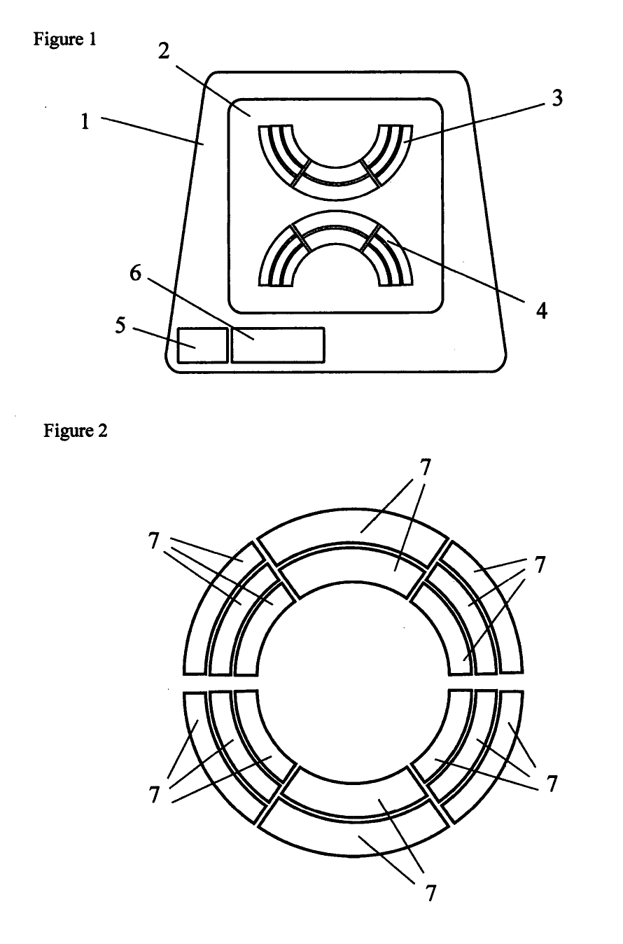

FIG. 1 shows one embodiment of a training device for use when brushing teeth showing a display and visual representation of a typical teeth layout on the display;

FIG. 2 shows the typical teeth diagram of FIG. 1 showing one arrangement of the teeth being divided up into a plurality of brushing zones;

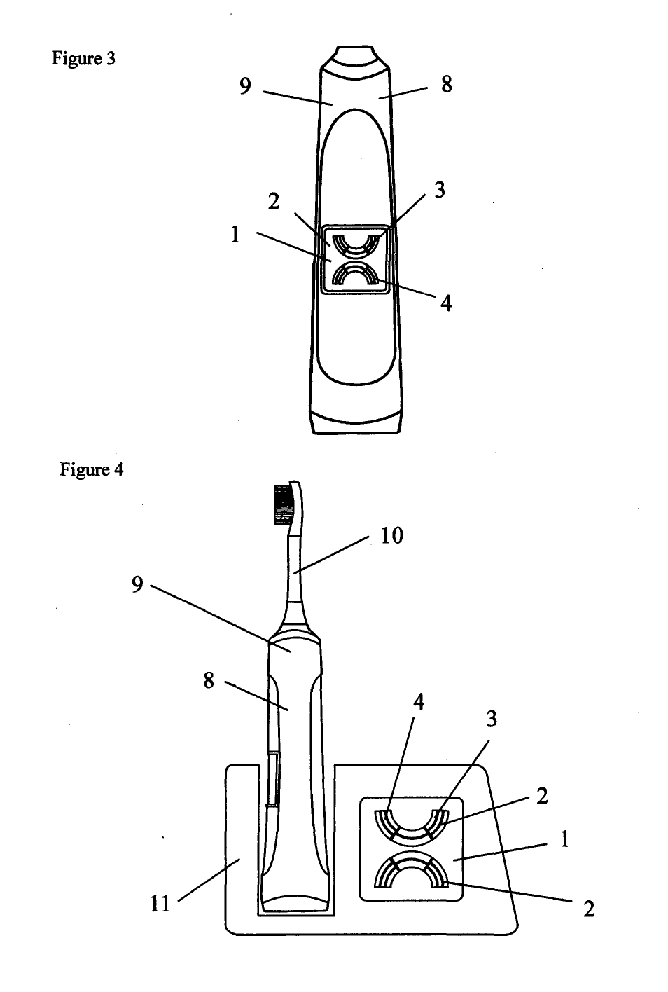

FIG. 3 shows a further embodiment of training device for use when brushing teeth when the training device is incorporated within the handle of an electric toothbrush;

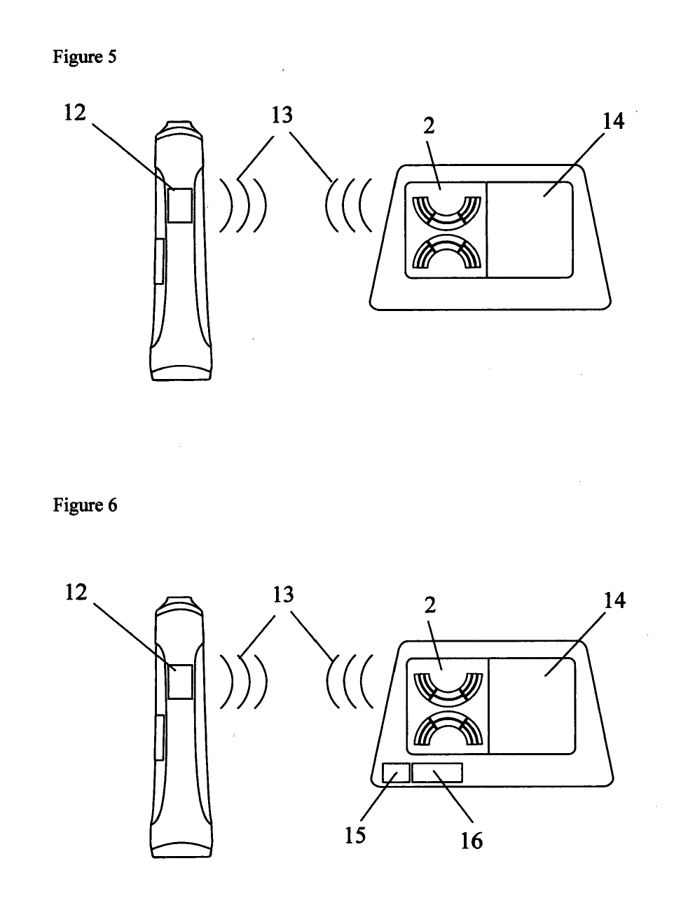

FIG. 4 shows yet a further embodiment of training device for use when brushing teeth when the training device is incorporated within a toothbrush docking station or electric toothbrush charging unit;

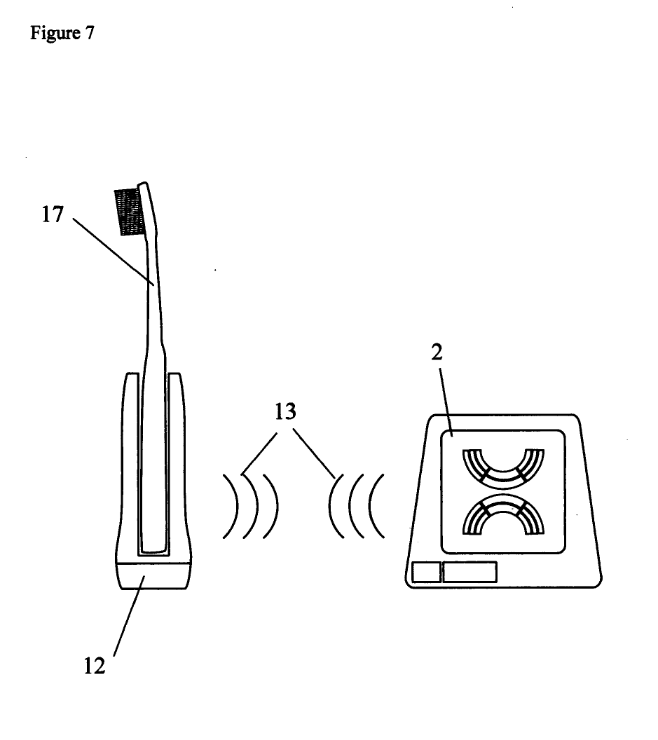

FIG. 5 shows the training device of FIG. 1 when operatively connected to an electric toothbrush handle for relaying brushing data from a plurality of sensors within the electric toothbrush handle;

FIG. 6 shows the training device arrangement of FIG. 5, with one embodiment of data processing mean and data storage unit;

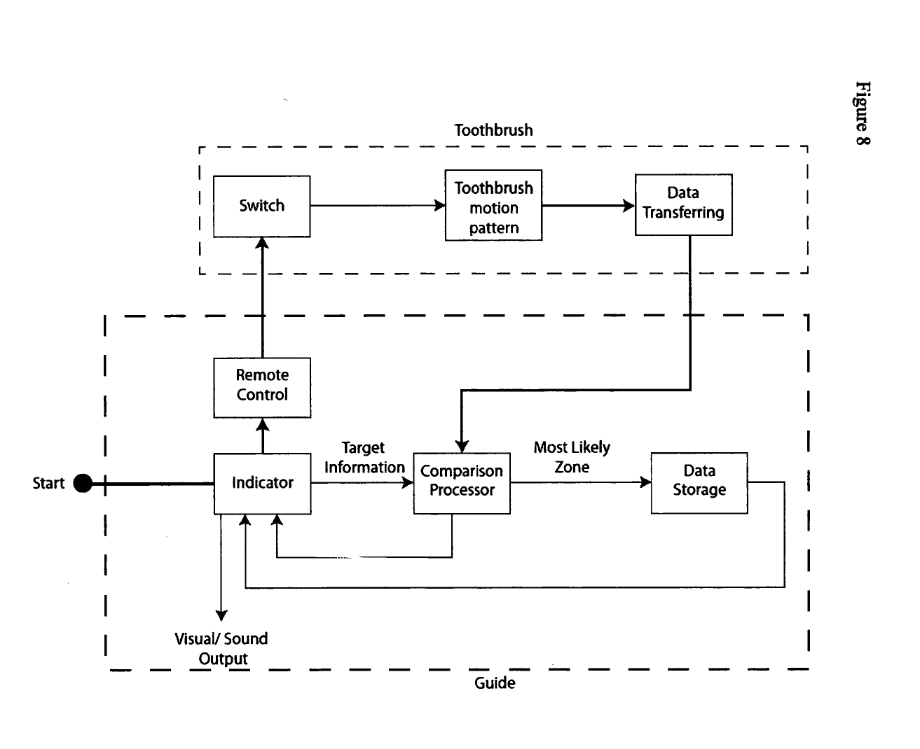

FIG. 7 shows yet a further embodiment of toothbrush training device operatively connected to a retrofittable toothbrush handle;

FIG. 8 shows a flow chart showing one embodiment of control of the toothbrush training device; and,

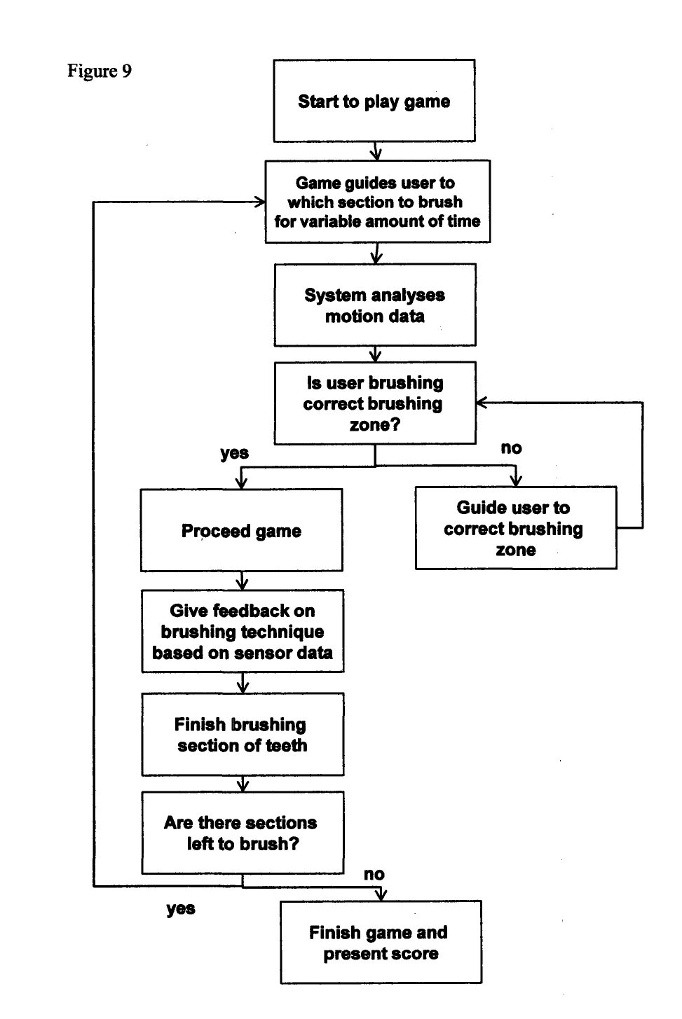

FIG. 9 shows a flow chart showing one embodiment of sequence of events when the toothbrush training device interacts with an interactive game.

In the figures like references denote like or corresponding parts.

As shown in FIG. 1, the training device 1 comprises a display means 2 configured to display a visual representation 3 of a user's set of teeth. The training device 1 accompanies a user when brushing their teeth, to guide them through a brushing session, ensuring that they brush every section of teeth for the recommended duration of time. The visual representation 3 incorporates indication means 4 to show which tooth of a set of teeth, or which array of teeth from a set of teeth should be brushed. FIG. 1 shows a standalone training device 1, with LCD display means 2. However, the training device may comprise a smartphone or tablet device whereby the screen forms the display means 2, and an App or software within the tablet device or smartphone is configured to provide a visual representation 3 on the display means 2 of a set of teeth. The display means 2 may also comprise a plurality of light-emitting diodes, configured in such an array as to represent a user's set of teeth. The light-emitting diodes are illuminated to provide indication means 4 to show which tooth or array of teeth from a set of teeth should be brushed at any one time.

The training device 1 also comprises a timer 5. The timer 5 is operatively connected to the display means 2, and the indication means 4 of the visual representation 3 within the display means 2, to keep track of time during a brushing session. The timer 5 may be configured to sequentially control the indication means 4 to indicate where using the indication means 4 where to brush in the mouth according to the visual representation 3. The timer 4 controls the duration of a brushing session, and indicated through the indication means 4 the beginning and end of a brushing session. A brushing session may be divided into brushing segments or time intervals. The indication means 4 indicates with a particular brushing zone on the visual representation 3 within which the user should brush for a particular time interval during a brushing session.

A typical brushing session would last 120 seconds, or 2 minutes, as this is the current recommendation for time to be spent brushing one's teeth during a brushing session. This brushing session would be divided up into brushing intervals. These brushing intervals during a brushing session can be of even duration. Alternatively, and in a preferred embodiment, the brushing intervals are randomised for each brushing session. A user may be directed to brush a particular brushing zone for 20 seconds, then to move to a different brushing zone for 30 seconds, before returning to the original brushing zone for 10 seconds to ensure that their interest is maintained. The randomising of the brushing intervals and brushing zones for each brushing session ensures that every brushing session is different.

In one embodiment these brushing intervals can be associated with music or audible alert means, so that the instruction to move to a different brushing zone 7 occurs in time with the rhythm of the music.

A programmable means 6 is operatively connected to the timer means 5 and the display means 2. The programmable means 6 may comprise a microprocessor. The programmable means 6 is configured to be programmed by a user, to obtain data about the user that is relevant to the brushing of their teeth. For an example such data might include their age, their name, whether they have any particular brushing requirements, whether they have any teeth missing or an array of teeth that is different to a standard array of teeth. Their dentist may have specific suggestions for how they might improve their tooth-brushing, and the programmable means 6 provides a store of such requirements, and controls the indication means 4 within the visual representation 3 of the display means 2 according to such requirements.

FIG. 2 shows one example of how the set of teeth of the visual representation 3 may be divided up into brushing zones 7. Each segment comprises a plurality of teeth, and each segment represents one brushing zone 7. The standard brushing zones 7 within the mouth comprise upper left molars and bicuspids, upper right molars and bicuspids, upper cuspids and incisors, lower left molars and bicuspids, lower right molars and bicuspids, lower cuspids and incisors. Each of these brushing zones 7 may be further divided into smaller brushing zones 7 that separate the outer surfaces of the teeth, the inner surfaces of the teeth, and where present, the chewing surfaces of the teeth. The molars have outer, inner and chewing surfaces, and therefore there may be three brushing zones 7 within these mouth sections.

The visual representation 3 may show a mirror image of a user's mouth when the user views the display means 2, such that when using the training device 1 the user follows the indication means 4 as if they are viewing their own mouth within a mirror.

Each brushing zone 7 comprises an outside surface of teeth, an inside surface of teeth, and some brushing zones 7 also comprise a chewing surface of teeth. The brushing zones 7 are altered according to the programmable means 6 and the data that a user has entered that is specific to their own mouth layout. For an example, a young child may not have so many teeth as an older child, and the brushing zones 7 are controlled by the programmable means 6 to ensure that the user brushes within the brushing zones 7 that are specific to their set of teeth.

Each brushing zone 7 may also be associated with a particular brushing technique. The programmable means 6 may control the display means 2 to show a particular brushing technique for the user to follow when brushing their teeth within a particular brushing zone 7.

A brushing session may be made up of any number of brushing intervals during which the user is instructed to brush a particular brushing zone 7. The user is alerted through the indication means 4 on the visual representation 3, or by alternative audible means, when to brush the teeth within a particular brushing zone, and what technique to follow when brushing the teeth within this particular zone. The brushing intervals may comprise at least 5 seconds, and the user may be directed to revisit a particular brushing zone 7 within a brushing session to ensure that each brushing zone 7 receives the predetermined amount of brushing.

FIG. 3 shows the training device 1 when incorporated within the handle 9 of an electric toothbrush 8. The display means 2 forms part of the handle 9 of the electric toothbrush 8, in place of the standalone unit. FIG. 4 shows a further embodiment where the training device 1 is configured within the docking station 11 of the electric toothbrush 8. The docking station 11 may provide storage or a holder for the electric toothbrush 8, and may also incorporate means to charge the electric toothbrush 8.

In a further embodiment of training device 1 for tooth brushing, the electric toothbrush 8 contains means to communicate with the training device 1, to feedback information about the user's brushing performance. The handle 9 of the electric toothbrush 8 may incorporate a plurality of sensors 12 to obtain data during a user's brushing session. FIG. 5 shows one arrangement where the handle 9 of the electric toothbrush 8 incorporates at least one sensor 12. There are a number of different sensors 12 that may be incorporated within the handle 9 to sense various conditions during a particular brushing session. The data obtained from the sensors 12 may be transmitted through wireless means 13 back to the training device 1. This data may be transferred real-time during a brushing session, or may be stored within the handle 9 of the electric toothbrush 8 and downloaded after a brushing session.

There are a number of different sensors 12 that may be incorporated within the handle 9, in combination or on their own, depending on the complexity of the training device 1 and the data to be obtained. The sensor 12 may comprise a motion sensor such as an accelerometer or similar. The accelerometer obtains data during a brushing session of the movement of the handle 9 of the electric toothbrush 8, and therefore gives an indication of motion of the brush head within the user's mouth. The sensor 12 may comprise a location determining sensor, such as a gyroscope or an accelerometer. The location determining sensor detects where the electric toothbrush 8 is located within a user's mouth, whilst also detecting the inclination of the brush head by determining the inclination of the handle 9 of the electric toothbrush 8. Each brushing zone 7 has a predetermined range of data within which the data obtained from the sensors 12 should aim to fall within. So a particular brushing zone 7 will have a predetermined and recorded set of limits for brush head position, and the data obtained from the at least one sensors 12 will be compared with this predetermined set of limits to see whether the user is brushing correctly within that brushing zone 7. The user is effectively obtaining a score for each brushing zone 7.

By receiving real-time feedback from the electric toothbrush 8, the training device 1 can make use of this feedback to monitor a user's performance during or after a brushing session. The data may influence the indication means 4 on the visual representation 3, whereby when the user is brushing specific teeth, the visual representation 3 is able to indicate through the indication means 4 on the display means 2 which brushing zone 7 is being brushed at any particular time. The data may also help the training device 1 to determine whether the correct brushing pressure is being applied, and therefore the correct brushing technique is being followed for a particular brushing zone 7. Examples of brushing techniques may include a circular brushing motion, a forward brushing motion or a backward brushing motion. The training device 1 can track whether the training sequence is being followed correctly, and feedback to the user as to how best to improve their tooth brushing activity. The timer 5 can track whether brushing zones 7 are being brushed for the correct brushing intervals, and whether a user is brushing correctly for a full brushing session. The training device 1 can also monitor how frequently a brushing session is being conducted by a particular user, such as whether they are brushing their teeth in the morning and in the evening.

The training device 1 can be configured to track whether the user is brushing specific problem areas with the correct technique, ensuring correct tooth brushing techniques, full teeth coverage and improving all round oral health. The training device 1 through providing randomised brushing intervals for each brushing zone 7 within the mouth, ensures that the user does not lose interest in engaging with the training device 1. For an example, each brushing zone 7 may be indicated a number of times during a brushing session for varying intervals of time, with the training device 1 ensuring that the random intervals add up to the required total brushing time for a particular brushing zone 7. The user therefore follows a different route when brushing their teeth each time they engage in a brushing session.

As shown in FIG. 5, the training device 1 incorporates an interactive gaming means 14 within the display 2, or as part of a separate display on the training device 1, not shown. The interactive gaming means 14 provides a story or game for the user to engage with whilst brushing their teeth. The brushing data obtained during the brushing session is transmitted real-time to the training device 1, and is used to alter the user's performance in the interactive gaming means 14. For an example, the user may be brushing too hard in a particular brushing zone 7. The at least one sensor 12 may comprise a pressure sensor that detects the pressure that the user is applying to their teeth within a particular brushing zone 7. This pressure data is transmitted, real-time, to the training device 1. The interactive gaming means 14 alters the user's performance within the game to reflect the fact that they are brushing too hard, by influencing certain attributes within the game to demonstrate their brushing technique being below what it should be. This gives them the opportunity to adapt their performance, in this case by reducing the brushing pressure exerted on their teeth within a particular brushing zone 7, to improve upon their performance within the game.

The brushing data from the sensors 12 may include, but not be limited to, any combination of the following: brush head pressure data, brush head brushing angle, brushing speed, brushing motion, location within a mouth. The brushing data obtained during a brushing session is used to interact with the interactive gaming means 14 to create a connection between gameplay and brushing technique. Brushing in the correct way and in the correct place can therefore create a positive outcome within the interactive gaming means 14.

FIG. 6 shows the training device 1 with processing means 16 that processes the data received from the electric toothbrush 8, and supplies this data to the interactive gaming means 14. The processing means 16 interprets the data and alters the performance within the interactive gaming means 14 accordingly. The user is therefore encouraged, by using the training device 1, to brush their teeth to the optimum standard during every brushing session. The training device 1 may also incorporate a data storage means 15, to store the data obtained from a particular brushing session. The data storage means 15 may also store or record the user's performance within the interactive gaming means 14. This allows the user to compete against other user's, to track their own brushing performance, to attempt to improve upon their previous performance, to download their brushing data for review by dental professionals, parents and other carers, and ultimately to keep them interested and involved with ensuring optimum dental hygiene. The data storage means 15 may comprise a diary to diarise and show the user's progress over time, marking days and times that they brushed their teeth, and their performance at these brushing sessions. The user can therefore keep track of their performance over time and see if they have improved.

The interactive gaming means 14 when the training device 1 is provided through a smartphone or tablet PC, may be provided through a downloadable application or App.

FIG. 7 shows a further embodiment where the electric toothbrush 8 is replaced by a manual toothbrush 17. The handle 9 provides a retrofittable handle 9 that can be fitted to any manual toothbrush 17, and contains the sensing means 12 or the at least one sensor 12 to determine how the manual toothbrush 17 is being used within a user's mouth. The handle 9 also contains the wireless means 13 to convey any brushing data obtained during a brushing session with the manual toothbrush 17 back to the training device 1. This embodiment allows the training device 1 to be used with any manual toothbrush 17. The user releasably secures the handle 9 to a manual toothbrush 17, and grips the handle 9 when brushing their teeth.

FIG. 8 shows a flow chart demonstrating one embodiment of interaction between the training device 1 and the toothbrush handle 9. FIG. 9 shows a flow chart indicating how the data obtained during a brushing session is used to affect the performance during a game or story within the interactive gaming means 14.

1. A training device for use when brushing teeth, the training device comprising:
a display means for displaying a visual representation of a set of teeth, said visual representation configured to display the set of teeth as a plurality of brushing zones;
an indication means for indicating on the visual representation each of the plurality of brushing zones;
a timer for timing a brushing session, and brushing intervals within said brushing session; and,
a programmable means operatively connected to said indication mean and said timer, the programmable means configured to control the indication means to indicate each brushing zone for each successive brushing interval during a brushing session, wherein the programmable means is configured to randomise the duration of each brushing interval, whilst ensuring that during a brushing session each brushing zone is indicated for a preset overall duration.

2. A training device according to claim 1, wherein the display means comprises an LCD display.

3. A training device according to claim 1, wherein the display means comprises a plurality of light-emitting diodes.

4. A training device according to claim 1, wherein the display means comprises a smartphone or tablet device.

5. A training device according to claim 3, wherein the indication means comprises a plurality of light-emitting diodes configured to represent a set of teeth.

6. A training device according claim 1, wherein the indication means is accompanied by an audible alert means.

7. A training device according to claim 6, wherein the audible alert means comprises a changing musical tune.

8. A training device according to claim 1, wherein the indication means is configured to indicate one of the following brushing zones for the duration of each brushing interval: upper left molars and bicuspids, upper right molars and bicuspids, upper cuspids and incisors, lower left molars and bicuspids, lower right molars and bicuspids, lower cuspids and incisors.

9. A training device according to claim 8, wherein the indication means is configured to indicate one of the following regions within each brushing zone for the duration of each brushing interval: outside surface, inside surface, chewing surface.

10. A training device according to claim 1, wherein the visual representation indicates brushing zones and at least one brushing technique for each brushing zone.

11. A training device according to claim 1, wherein the visual representation shows a mirror image of a set of teeth.

12. A training device according to claim 1, wherein the training device is operatively connected to at least one sensor within a toothbrush handle, said sensor configured to obtain data for determining at least one of the following conditions: toothbrush head angle, brushing zone location, brushing motion pattern, brushing pressure, brushing speed.

13. A training device according to claim 12, wherein the sensor comprises a motion sensor.

14. A training device according to claim 13, wherein the motion sensor comprises an accelerometer.

15. A training device according to claim 12, wherein the sensor comprises a capacitative sensor.

16. A training device according to claim 12, wherein the sensor comprises a gyroscope.

17. A training device according to claim 1, wherein the at least one sensor comprises an accelerometer, a gyroscope and a pressure sensor to determine brushing frequency, brushing angle and brushing position.

18. A training device according to claim 1, wherein the programmable means can be programmed for a particular user profile and/or user brushing history.

19. A training device according to claim 12, wherein the training device is operatively connected to the toothbrush handle through wireless means to wirelessly transfer brushing data from the at least one sensor.

20. A training device according to claim 18, wherein the training device comprises a processor configured to compare brushing data with preset brushing data for a particular user.

21. A training device according to claim 19, wherein the processor is configured to alter the programmable means to vary brushing intervals and brushing zones in response to any received brushing data for the user's successive brushing session.

22. A training device according to claim 12, wherein the training device provides real-time feedback as to brushing technique.

23. A training device according to claim 21, wherein said real-time feedback is in the form of an interactive game.

24. A training device according to claim 23, wherein a user's performance within the interactive game is real-time controlled by the user's brushing data during a particular brushing session.

25. A training device according to claim 22, wherein the audible alert means is configured to change according to the brushing data generated during a brushing session when compared with the preset brushing data.

26. A training device according to claim 12, wherein the training device comprises data storage means to store said brushing data for a particular user.

27. A training device for use when brushing teeth, the training device comprising:
audible means for alerting a user where to brush their teeth;
a timer for timing a brushing session, and brushing intervals within said brushing session; and,
a programmable means operatively connected to said audible means and said timer, the programmable means configured to control the audible means to alert where to brush for each successive brushing interval during a brushing session, wherein the programmable means is configured to randomise the duration of each brushing interval, whilst ensuring that during a brushing session each brushing zone is indicated for a preset overall duration.

28. A training device for use when brushing teeth, the training device comprising:
a display means for displaying a visual representation of a set of teeth;
a timer for timing a brushing session, and brushing intervals within said brushing session; and,
a programmable means operatively connected to said display means and said timer, the programmable means configured to control the display means to indicate each brushing zone for each successive brushing interval during a brushing session, wherein the display means is configured to indicate a specific brushing technique for each brushing zone.

29. A training device according to claim 28, wherein the display means is configured to display real-time feedback in the form of an interactive game.

30. An electric toothbrush handle incorporating the training device of claim 1.

31. An electric toothbrush docking station incorporating the training device of claim 1.

32. A retrofittable attachment for retrofitting to the handle of any manual and/or electric toothbrush incorporating the training device of claim 1.

33. A retrofittable attachment of claim 32, incorporating at least one sensor for generating brushing data.

34. (canceled)
